(19) United States
(12) Patent Application Publication
(10) Pub. No.: US 2026/0124881 A1
(43) Pub. Date: May 7, 2026

(54) OPTIMAL BUS VOLTAGE AND SWITCHING FREQUENCY STRATEGY

(71) Applicant: Carrier Corporation, Palm Beach Gardens, FL (US)

(72) Inventors: Jaegue Shin, Fort Lee, NJ (US); Ismail Agirman, Southington, CT (US); Luis Arnedo, South Glastonbury, CT (US); David Ginsberg, Granby, CT (US); Xuqiang Liao, Syracuse, NY (US)

(21) Appl. No.: 19/377,420

(22) Filed: Nov. 3, 2025

Related U.S. Application Data
(60) Provisional application No. 63/715,710, filed on Nov. 4, 2024.

(51) Int. Cl. B60H 1/32

(52) U.S. Cl. CPC B60H 1/3211; B60H 1/3229; B60H 2001/325; B60H 2001/3258; B60H 2001/3272

(57) ABSTRACT

A transportation refrigeration system is provided and includes a trailer refrigeration unit (TRU), a battery to provide electricity for the TRU, an electrical system and a controller. The electrical system includes a direct current (DC) bus electrically interposed between the battery and the TRU. The electrical system further includes an inverter and a boost converter disposed on the DC bus. The controller includes a memory unit storing first, second and third efficiency tables for the TRU, the inverter and the boost converter, respectively, and a processor. The processor sets an operational target for the TRU and achieves the operational target by controlling the inverter and the boost converter according to a voltage of the battery, the first, second and third efficiency tables and real-time operating conditions.

### CROSS-REFERENCE TO RELATED APPLICATIONS

This application claims the benefit of U.S. provisional patent application Ser. No. 63/715,710, filed Nov. 4, 2024, the entire contents of which are incorporated herein by reference.

### BACKGROUND

The present disclosure relates to compressor systems and, more particularly, to an optimal direct current (DC) bus voltage and switching frequency strategy for a compressor system.

Refrigerated vehicles transport perishable or temperature-sensitive goods within logistics networks. Refrigerated vehicles typically include a trailer refrigeration unit (TRU) that regulates the environment within a storage area of the vehicle, such as a container or trailer, within which the goods are stored during transit. The TRU includes a refrigeration system or the like, which is powered by an energy source. Traditionally, in the case of a tractor-trailer system where the storage area is within the trailer, the trailer has been provided with an internal combustion engine to power the TRU. The internal combustion engine of the TRU is separate from the internal combustion engine of the tractor providing motive force.

In recent years, electrical power sources have been used to power the TRU, rather than internal combustion engines. Such electrical power sources may include batteries that are charged using electrical energy from an electrical grid and/or a generator coupled to a wheel axle of the trailer. This increases the fuel consumption of the internal combustion engine of the tractor, but permits the use of a smaller battery.

### BRIEF DESCRIPTION

According to an aspect of the disclosure, a transportation refrigeration system is provided and includes a trailer refrigeration unit (TRU), a battery to provide electricity for the TRU, an electrical system and a controller. The electrical system includes a direct current (DC) bus electrically interposed between the battery and the TRU. The electrical system further includes an inverter and a boost converter disposed on the DC bus. The controller includes a memory unit storing first, second and third efficiency tables for the TRU, the inverter and the boost converter, respectively, and a processor. The processor sets an operational target for the TRU and achieves the operational target by controlling the inverter and the boost converter according to a voltage of the battery, the first, second and third efficiency tables and real-time operating conditions.

In accordance with one or more additional and/or alternative embodiments, the controller is distributed between the inverter and the boost converter.

In accordance with one or more additional and/or alternative embodiments, the controller controls the inverter and the boost converter by issuing first and second signals to the inverter and the boost converter, respectively.

In accordance with one or more additional and/or alternative embodiments, the first and second signals include pulse width modulation (PWM) signals.

In accordance with one or more additional and/or alternative embodiments, the first, second and third efficiency tables are based on historical data and are updateable.

In accordance with one or more additional and/or alternative embodiments, the operational target includes a compressor speed.

In accordance with one or more additional and/or alternative embodiments, the real-time operating conditions include at least one or more of ambient temperature and pressure characteristics around the TRU, temperature and pressure characteristics of a container to be conditioned by the TRU, pressure and flow rate characteristics of the TRU and additional electrical characteristics of the electrical system.

In accordance with one or more additional and/or alternative embodiments, the processor is configured to determine a maximally efficient voltage requirement for the compressor speed and a voltage difference between the voltage of the battery and the voltage requirement, modulate switching frequencies of the boost converter to compensate for the voltage difference with maximum efficiency and modulate switching frequencies of the inverter to build a sinusoidal voltage output from boost converter output with maximum efficiency.

According to an aspect of the disclosure, a transportation refrigeration system is provided and includes trailer refrigeration units (TRUs), loads, a battery to provide electricity for the TRUs and the loads, an electrical system and a controller. The electrical system includes a direct current (DC) bus electrically interposed between the battery and the TRUs and the loads. The electrical system further includes inverters for each TRU and each load and boost converters for some inverters disposed on the DC bus. The controller includes a memory unit storing first, second and third efficiency tables for the TRUs and the loads, the inverters and the boost converters, respectively, and a processor. The processor sets operational targets for the TRUs and the loads and achieves the operational targets by controlling the inverters and the boost converters according to a voltage of the battery the first, second and third efficiency tables and real-time operating conditions.

In accordance with one or more additional and/or alternative embodiments, the first, second and third efficiency tables are based on historical data and are updateable.

In accordance with one or more additional and/or alternative embodiments, the operational targets for the TRUs include compressor speeds.

In accordance with one or more additional and/or alternative embodiments, the real-time operating conditions include at least one or more of ambient temperature and pressure characteristics around the TRUs and the loads, temperature and pressure characteristics of containers to be conditioned by the TRUs and the loads, pressure and flow rate characteristics of the TRUs and the loads and additional electrical characteristics of the electrical system.

In accordance with one or more additional and/or alternative embodiments, the processor is configured to determine maximally efficient voltage requirements for the compressor speeds and voltage differences between the voltage of the battery and the voltage requirements, modulate switching frequencies of the boost converters to compensate for the voltage differences with maximum efficiency and modulate switching frequencies of the inverters to build sinusoidal voltage outputs from boost converter outputs with maximum efficiency.

According to an aspect of the disclosure, a method of operating a transportation refrigeration system including a trailer refrigeration unit (TRU) and a battery to provide electricity for the TRU is provided. The method includes setting a compressor speed of the TRU for a target temperature of a container, referring to an efficiency table of the TRU to determine a voltage requirement of the compressor speed, determining a voltage difference between a voltage of the battery and the voltage requirement and compensating for the voltage difference to achieve the target temperature by controlling an inverter and a boost converter disposed on a direct current (DC) bus of an electrical system electrically interposed between the battery and the TRU in accordance with efficiency tables of the inverter and the boost converter and real-time operating conditions.

In accordance with one or more additional and/or alternative embodiments, the controlling of the inverter and the boost controller includes issuing pulse width modulation (PWM) signals to the inverter and the boost converter.

In accordance with one or more additional and/or alternative embodiments, the method further includes modulating the PWM signals to the inverter and the boost converter.

In accordance with one or more additional and/or alternative embodiments, the modulating of the PWM signals to the inverter changes a duty cycle of the inverter to build a sinusoidal voltage output from boost converter output.

In accordance with one or more additional and/or alternative embodiments, the modulating of the PWM signals to the boost converter changes a duty cycle of the boost converter to obtain a desired output voltage.

In accordance with one or more additional and/or alternative embodiments, the method further includes generating the efficiency tables of the TRU, the inverter and the boost converter based on historical data and updating the efficiency tables of the TRU, the inverter and the boost converter.

In accordance with one or more additional and/or alternative embodiments, the real-time operating conditions include at least one or more of ambient temperature and pressure characteristics around the TRU, temperature and pressure characteristics of a container to be conditioned by the TRU, pressure and flow rate characteristics of the TRU and additional electrical characteristics of the electrical system.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a schematic diagram of a transportation refrigeration system with a battery and a TRU in accordance with embodiments;

FIG. 2 is a graphical depiction of an efficiency table for the transportation refrigeration system of FIG. 1 in accordance with embodiments;

FIG. 3 is a schematic diagram of a controller of the transportation refrigeration system of FIG. 1 in accordance with embodiments;

FIG. 4 is a schematic diagram of a transportation refrigeration system with a battery and multiple TRUs and loads in accordance with embodiments;

FIG. 5 is a schematic diagram of a controller of the transportation refrigeration system of FIG. 4 in accordance with embodiments; and

FIG. 6 is a flow diagram illustrating a method of operating a transportation refrigeration system including a TRU and a battery to provide electricity for the TRU in accordance with embodiments.

### DETAILED DESCRIPTION

Recently, efforts have been made to electrify truck and trailer products. These efforts involve replacing diesel generators with electric drives to run a TRU motor by electric energy from a battery. A problem with such arrangements, however, is that they tend to be inefficient. The inefficiency can stem from a lack of DC bus voltage and switching frequency management capabilities which, in turn, can lead to energy losses, poor system performance and shortened component lifespans.

Thus, as will be described below, a method is provided for dynamically adjusting a DC bus voltage level and a switching frequency for a compressor system, which includes an electric drive to run a TRU motor by electric energy from a battery, based on real-time operating conditions, load demands and other relevant parameters. By employing advanced algorithms that consider various factors including, but not limited to, temperature, pressure, flow rate and electrical characteristics of the compressor system, the method ensures optimal efficiency across a wide range of operating scenarios by providing for a self-adjusting mechanism that responds to changing conditions without manual intervention, thereby maintaining peak performance while reducing energy consumption.

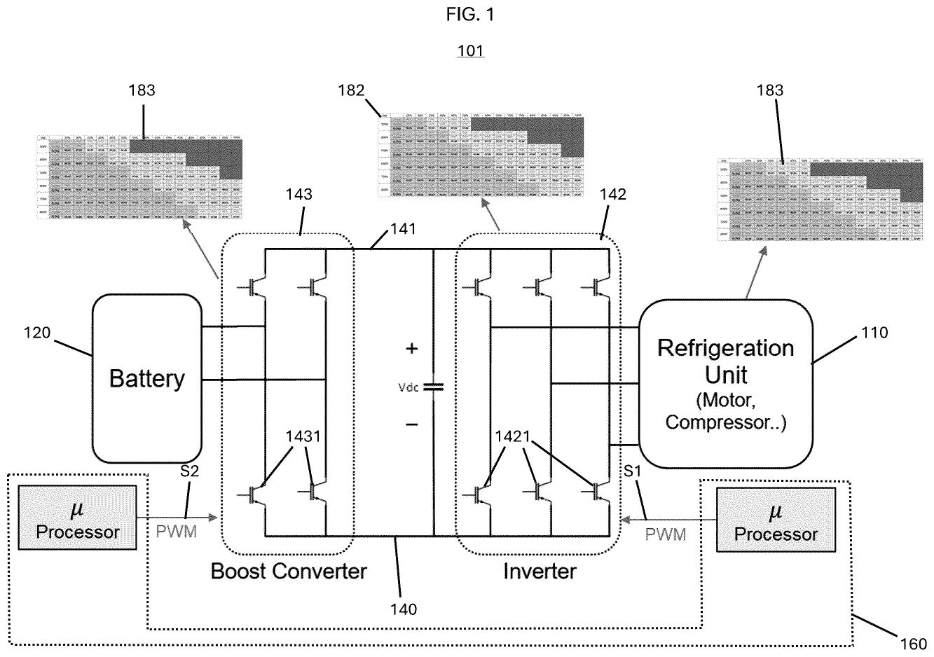

With reference to FIGS. 1-3, a transportation refrigeration system 101 is provided and includes a TRU 110, a battery 120 to provide electricity for the TRU 110, an electrical system 140 and a controller 160. The electrical system 140 includes a DC bus 141 that is electrically interposed between the battery 120 and the TRU 110. The electrical system 140 further includes an inverter 142 and a boost converter 143, which are both disposed on the DC bus 141. The inverter 142 includes a plurality of switches 1421, such as transistor elements. Switching frequencies of the switches 1421 can be affected and controlled as discussed below. The boost converter 143 includes a plurality of switches 1431, such as transistor elements. Switching frequencies of the switches 1431 can be affected and controlled also as discussed below.

It is to be understood that a total efficiency η_total of the transportation refrigeration system 101 is equal to the efficiency of the boost converter 143 η_boost multiplied by the efficiency of the inverter 142 η_inv multiplied by the efficiency of the TRU 110 η_unit.

$${η}_{total} = {η}_{b o o s t} \cdot {η}_{inv} \cdot {η}_{unit}$$

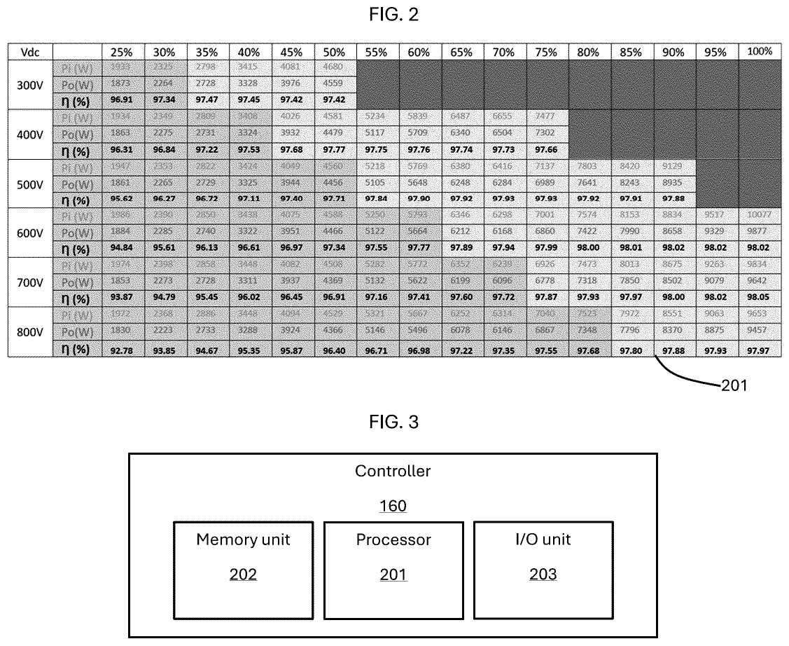

The controller 160 includes a processor 201, a memory unit 202 and an input/output (I/O) unit 203 by which the processor 201 is receptive of voltage information of the battery 120 and real-time operating conditions and by which the processor 201 issues signals to the TRU 110, the inverter 142 and the boost converter 143. The memory unit 202 has executable instructions stored thereon, which are readable and executable by the processor 201, and also has a first efficiency table 181 for the TRU 110, a second efficiency table 182 for the inverter 142 and a third efficiency table 183 for the boost converter 143 (see, e.g., exemplary efficiency table 201 of FIG. 2) stored thereon to be accessed by the processor 201. Each of the first efficiency table 181, the second efficiency table 182 and the third efficiency table 183 can be generated based on historical data and are updateable as new data is received and analyzed.

The first efficiency table 181, the second efficiency table 182 and the third efficiency table 183 can each associate a maximum efficiency with certain combinations of selectable variables. As an example, as shown in FIG. 2, the efficiency table 201 indicates that a maximum efficiency is achieved at a 50% duty cycle for a voltage of 400V and that a maximum efficiency is achieved at a 55% duty cycle for a voltage of 500V.

When the executable instructions are read and executed by the processor 201, the processor 201 is caused to operate generally as described herein. That is, when the executable instructions are read and executed by the processor 201, the processor 201 sets an operational target (i.e., a first selectable variable) for the TRU 110 and achieves the operational target with maximum efficiency by controlling the inverter 142 (i.e., second selectable variables of the inverter 142) and the boost converter 143 (i.e., third selectable variables of the boost converter 143) according to a voltage of the battery 120, according to readouts by the processor 201 of the first, second and third efficiency tables 181, 182 and 183 and according to real-time operating conditions received by the processor 201. In accordance with embodiments, the operational target may be a compressor speed for a compressor motor of the TRU 110 and the real-time operating conditions may include at least one or more of ambient temperature and pressure characteristics around the TRU 110, temperature and pressure characteristics of a container to be conditioned by the TRU 110, pressure and flow rate characteristics of the TRU 110 and additional electrical characteristics of the electrical system 140.

In accordance with embodiments, the processor 201 determines a maximally efficient voltage requirement for the compressor speed and a voltage difference between the voltage of the battery 120 and the voltage requirement, modulates the switching frequencies of the switches 1431 of the boost converter 143 to compensate for the voltage difference with maximum efficiency and modulates switching frequencies of the switches 1421 of the inverter 142 to build a sinusoidal voltage output from an output of the boost converter 143 with maximum efficiency.

The first, second and third efficiency tables 181, 182 and 183 can be modified (i.e., automatically) in accordance with real-time changes of the real-time operating conditions. That is, for the first efficiency table 181 for the TRU 110, there may be a certain compressor speed at a certain voltage of the DC bus 141 which is associated with maximum efficiency of the TRU 110 given certain real-time operating conditions. However, if those real-time operating conditions change, the first efficiency table 181 may dictate that maximum efficiency is achieved at a different compressor speed at the same voltage of the DC bus 141. Similar effects may take place for the second and third efficiency tables 182 and 183 as well.

The controlling of the inverter 142 and the boost converter 143 can be accomplished by the processor 201 issuing signals S1 and S2 to the inverter 142 and the boost converter 143, respectively. In accordance with embodiments, the signals S1 and S2 can be provided as pulse width modulation (PWM) signals that determine the switching frequencies of the switches 1431 of the boost converter 143 and the switching frequencies of the switches 1421 of the inverter 142.

The boost converter 143 effectively controls the bus voltage of the DC bus 141 as its output. In an ideal scenario, the output voltage of the boost converter 143 is Vout−Vin (1−D), where Vout is the voltage output of the boost converter 143, Vin is the voltage of the battery 120 and D is the duty ratio of the signal 2 PWM signal. For example, when D=0.5 (50%), Vout=Vin/(1−0.5)=2*Vin such that Vout is double that of Vin. The processor 201 commands the signal S2 PWM with the duty ratio to get the desired output voltage of the boost converter 143.

With PWM control of the inverter 142, the inverter 142 generates a 3-phase AC output voltage from the voltage of the DC bus 141 (which may or may not be boosted by the boost converter 143). The processor 201 continually changes the PWM duty ratio to build a sinusoidal voltage output by which the speed of the motor of the compressor of the TRU 110 is controlled to achieve a desired compressor speed.

The controller 160 can be at least any one or more of a stand-alone computing device, a remote computing device and/or embodied as computing resources that are distributed between at least the inverter 142 and the boost converter 143 and the battery 120 and the TRU 110.

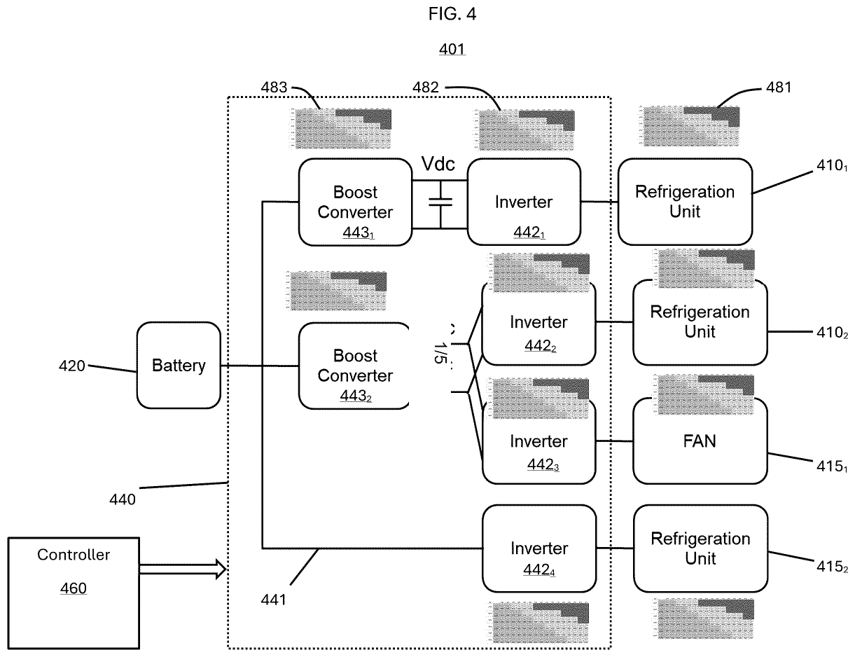

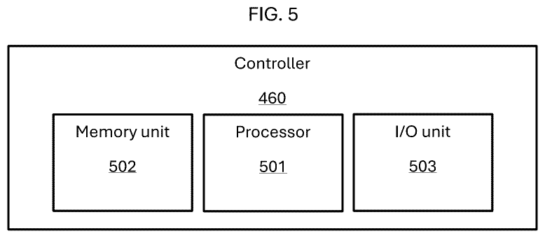

With continued reference to FIGS. 1-3 and with additional reference to FIGS. 4 and 5, a transportation refrigeration system 401 is provided. The transportation refrigeration system 401 is generally similar to the transportation refrigeration system 101 of FIGS. 1-3 and like elements between the two need not be described further. The transportation refrigeration system 401 includes TRUs 410₁ and 410₂ and loads 415₁ and 415₂, a battery 420 to provide electricity for the TRUs 410₁ and 410₂ and the loads 415₁ and 415₂, an electrical system 440 and a controller 460. The electrical system 440 includes a DC bus 441, which is electrically interposed between the battery 420 and the TRUs 410₁ and 410₂ and the loads 415₁ and 415₂ and further includes inverters 442₁₋₄ for each of the TRUs 410₁ and 410₂ and each of the loads 415₁ and 415₂ and boost converters 443₁ and 443₂ for some inverters 442₁₋₄ disposed on the DC bus 441.

The controller 460 includes a processor 501, a memory unit 502 and an I/O unit 503 by which the processor 501 is receptive of voltage information of the battery 420 and real-time operating conditions and by which the processor 501 issues signals to the TRUs 410₁ and 410₂ and the loads 415₁ and 415₂, the inverters 442₁₋₄ and the boost converters 443₁ and 443₂. The memory unit 502 has executable instructions stored thereon, which are readable and executable by the processor 501, and also has first efficiency tables 481 for the TRUs 410₁ and 410₂ and the loads 415₁ and 415₂, second efficiency tables 482 for the inverters 442₁₋₄ and third efficiency tables 483 for the boost converters 443₁ and 443₂. Each of the first efficiency tables 481, the second efficiency tables 482 and the third efficiency tables 483 can be generated based on historical data and are updateable as new data is received and analyzed.

When the executable instructions are read and executed by the processor 501, the processor 501 is caused to operate generally as described herein. That is, when the executable instructions are read and executed by the processor 501, the processor 501 sets operational targets for the TRUs 410₁ and 410₂ and the loads 415₁ and 415₂ and achieves the operational targets with maximum efficiency by controlling the inverters 442₁₋₄ and the boost converters 443₁ and 443₂ according to a voltage of the battery 420, according to readouts by the processor 601 of the first, second and third efficiency tables 481, 482 and 483 and according to real-time operating conditions received by the processor 401.

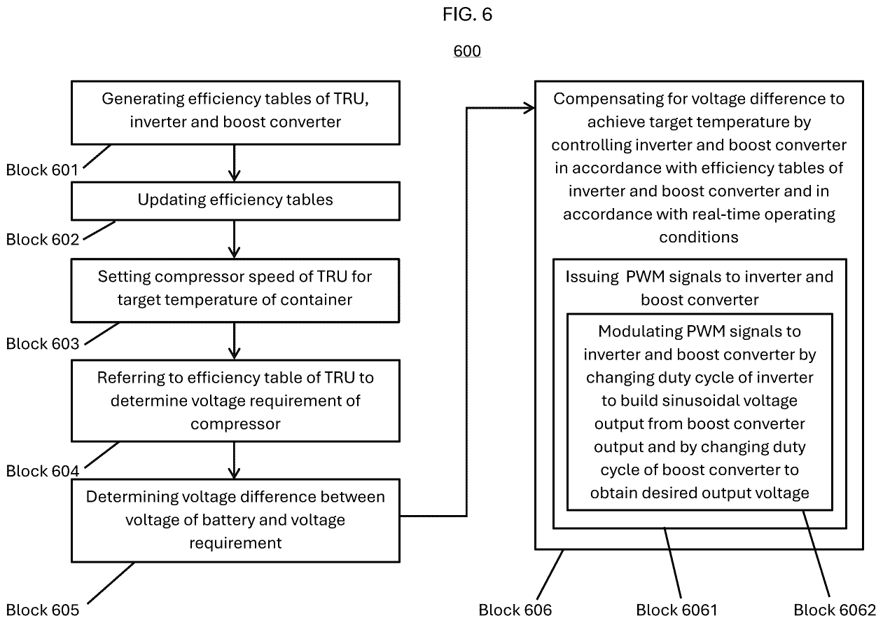

With reference to FIG. 6, a method 600 of operating a transportation refrigeration system including a TRU, a battery to provide electricity for the TRU and an inverter and a boost converter that are disposed on a DC bus of an electrical system electrically interposed between the battery and the TRU, such as the transportation refrigeration system 101 of FIGS. 1-3 and the transportation refrigeration system 401 of FIGS. 4 and 5. The method 600 initially includes generating efficiency tables of the TRU, the inverter and the boost converter based on historical data and (block 601) and updating the efficiency tables of the TRU, the inverter and the boost converter (block 602). The method 600 further includes setting a compressor speed of the TRU for a target temperature of a container (block 603) and referring to the efficiency table of the TRU to determine a voltage requirement of the compressor speed (block 604). The method 600 also includes determining a voltage difference between a voltage of the battery and the voltage requirement (block 605) and compensating for the voltage difference to achieve the target temperature by controlling the inverter and the boost converter in accordance with the efficiency tables of the inverter and the boost converter and in accordance with real-time operating conditions (block 606). The real-time operating conditions can include at least one or more of ambient temperature and pressure characteristics around the TRU, temperature and pressure characteristics of a container to be conditioned by the TRU, pressure and flow rate characteristics of the TRU and additional electrical characteristics of the electrical system. The controlling of the inverter and the boost controller of block 606 can include issuing PWM signals to the inverter and the boost converter (block 6061) and modulating the PWM signals to the inverter and the boost converter by changing a duty cycle of the inverter to build a sinusoidal voltage output from boost converter output and by changing a duty cycle of the boost converter to obtain a desired output voltage (block 6062).

Technical effects and benefits of the present disclosure are the provision of an optimal DC bus voltage and switching frequency strategy for a compressor system, which includes an electric drive to run a TRU motor by electric energy from a battery. The strategy enhances overall efficiencies by intelligently managing a DC bus voltage and a switching frequency of power electronic switches involved in the running of the TRU motor by the electric energy from the battery. The strategy minimizes energy losses, improves system performance and extends the lifespan of components within compressor systems.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A transportation refrigeration system, comprising:
a trailer refrigeration unit (TRU);
a battery to provide electricity for the TRU;
an electrical system comprising a direct current (DC) bus electrically interposed between the battery and the TRU and further comprising an inverter and a boost converter disposed on the DC bus; and
a controller comprising:
a memory unit storing first, second and third efficiency tables for the TRU, the inverter and the boost converter, respectively; and
a processor to set an operational target for the TRU and to achieve the operational target by controlling the inverter and the boost converter according to a voltage of the battery, the first, second and third efficiency tables and real-time operating conditions.

2. The transportation refrigeration system according to claim 1, wherein the controller is distributed between the inverter and the boost converter.

3. The transportation refrigeration system according to claim 1, wherein the controller controls the inverter and the boost converter by issuing first and second signals to the inverter and the boost converter, respectively.

4. The transportation refrigeration system according to claim 3, wherein the first and second signals comprise pulse width modulation (PWM) signals.

5. The transportation refrigeration system according to claim 1, wherein the first, second and third efficiency tables are based on historical data and are updateable.

6. The transportation refrigeration system according to claim 1, wherein the operational target comprises a compressor speed.

7. The transportation refrigeration system according to claim 6, wherein the real-time operating conditions comprise at least one or more of ambient temperature and pressure characteristics around the TRU, temperature and pressure characteristics of a container to be conditioned by the TRU, pressure and flow rate characteristics of the TRU and additional electrical characteristics of the electrical system.

8. The transportation refrigeration system according to claim 6, wherein the processor is configured to:
determine a maximally efficient voltage requirement for the compressor speed and a voltage difference between the voltage of the battery and the voltage requirement, modulate switching frequencies of the boost converter to compensate for the voltage difference with maximum efficiency, and
modulate switching frequencies of the inverter to build a sinusoidal voltage output from boost converter output with maximum efficiency.

9. A transportation refrigeration system, comprising:
trailer refrigeration units (TRUs);
loads;
a battery to provide electricity for the TRUs and the loads;
an electrical system comprising a direct current (DC) bus electrically interposed between the battery and the TRUs and the loads and further comprising inverters for each TRU and each load and boost converters for some inverters disposed on the DC bus; and
a controller comprising:
a memory unit storing first, second and third efficiency tables for the TRUs and the loads, the inverters and the boost converters, respectively; and
a processor to set operational targets for the TRUs and the loads and to achieve the operational targets by controlling the inverters and the boost converters according to a voltage of the battery the first, second and third efficiency tables and real-time operating conditions.

10. The transportation refrigeration system according to claim 9, wherein the first, second and third efficiency tables are based on historical data and are updateable.

11. The transportation refrigeration system according to claim 9, wherein operational targets for the TRUs comprise compressor speeds.

12. The transportation refrigeration system according to claim 11, wherein the real-time operating conditions comprise at least one or more of ambient temperature and pressure characteristics around the TRUs and the loads, temperature and pressure characteristics of containers to be conditioned by the TRUs and the loads, pressure and flow rate characteristics of the TRUs and the loads and additional electrical characteristics of the electrical system.

13. The transportation refrigeration system according to claim 11, wherein the processor is configured to:
determine maximally efficient voltage requirements for the compressor speeds and voltage differences between the voltage of the battery and the voltage requirements,
modulate switching frequencies of the boost converters to compensate for the voltage differences with maximum efficiency, and
modulate switching frequencies of the inverters to build sinusoidal voltage outputs from boost converter outputs with maximum efficiency.

14. A method of operating a transportation refrigeration system comprising a trailer refrigeration unit (TRU) and a battery to provide electricity for the TRU, the method comprising:
setting a compressor speed of the TRU for a target temperature of a container;
referring to an efficiency table of the TRU to determine a voltage requirement of the compressor speed;
determining a voltage difference between a voltage of the battery and the voltage requirement; and
compensating for the voltage difference to achieve the target temperature by controlling an inverter and a boost converter disposed on a direct current (DC) bus of an electrical system electrically interposed between the battery and the TRU in accordance with efficiency tables of the inverter and the boost converter and real-time operating conditions.

15. The method according to claim 14, wherein the controlling of the inverter and the boost controller comprises issuing pulse width modulation (PWM) signals to the inverter and the boost converter.

16. The method according to claim 15, wherein the method further comprises modulating the PWM signals to the inverter and the boost converter.

17. The method according to claim 16, wherein the modulating of the PWM signals to the inverter changes a duty cycle of the inverter to build a sinusoidal voltage output from boost converter output.

18. The method according to claim 16, wherein the modulating of the PWM signals to the boost converter changes a duty cycle of the boost converter to obtain a desired output voltage.

19. The method according to claim 14, further comprising generating the efficiency tables of the TRU, the inverter and the boost converter based on historical data and updating the efficiency tables of the TRU, the inverter and the boost converter.

20. The method according to claim 14, wherein the real-time operating conditions comprise at least one or more of ambient temperature and pressure characteristics around the TRU, temperature and pressure characteristics of a container to be conditioned by the TRU, pressure and flow rate characteristics of the TRU and additional electrical characteristics of the electrical system.
